(19) United States
(12) Patent Application Publication
(10) Pub. No.: US 2009/0149317 A1
(43) Pub. Date: Jun. 11, 2009

(54) PROCESS FOR THE PREPARATION OF AN ALUMINIUM PHOSPHATE CONTAINING CATALYST COMPOSITION

(75) Inventors: Dennis Stamires, Dana Point, CA (US); Paul O'Connor, Hoevelaken (NL)

Correspondence Address: Albemarle Netherlands B.V.;Patent and Trademark Department, 451 Florida Street, Baton Rouge, LA, 70801, US

(73) Assignee: ALBEMARLE NETHERLANDS B.V., AMERSFOORT (NL)

(21) Appl. No.: 12/093,104

(22) PCT Filed: Nov. 7, 2006
(86) PCT No.: PCT/EP2006/068164

§ 371 Date: Nov. 4, 2008

Related U.S. Application Data
(60) Provisional application No. 60/735,245, filed on Nov. 8, 2005.

(51) Int. Cl. B01J 21/16

(52) U.S. Cl. 502/63

(57) ABSTRACT

Process for the preparation of an aluminium phosphate-containing composition wherein an aluminium source is converted partly to aluminium phosphate using a phosphorus-containing compound and partly to (i) an anionic clay and/or a Al-M^{II} mixed metal (hydr)oxide using a divalent metal (M^{II}) source, (ii) an aluminosilicate using a silicon source, and/or (iii) a M^{II}- aluminosilicate using both a divalent metal source and a silicon source.

The invention relates to a process for the preparation of an aluminium phosphate-containing catalyst composition.

Aluminium phosphate-containing catalyst compositions are known from the prior art. For example, EP 0 496 226 discloses a catalyst composition comprising a zeolite, an aluminium phosphate-containing binder, and optionally an inorganic oxide such as kaolin. The composition is prepared by reacting phosphoric acid and an aluminium salt solution to form an aluminium phosphate solution and mixing the aluminium phosphate solution with the zeolite and the optional inorganic oxide. The resulting mixture is spray-dried.

U.S. Pat. No. 6,355,591 discloses a fluid catalytic cracking additive composition comprising 4-20 wt % aluminium phosphate, 1-40 wt % crystalline molecular sieve zeolites selected from the group consisting of mordenite, ZSM-5, beta, and mixtures thereof, and 40-90 wt % clay, i.e. kaolin. The composition is prepared by reacting aluminium metal powder with phosphoric acid to obtain aluminium phosphate, mixing the aluminium phosphate with clay, adding this mixture to a zeolite-containing slurry, followed by spray-drying and calcination.

Hence, these published catalyst compositions are prepared by mixing aluminium phosphate with the other catalyst components, e.g. zeolite and clay, leading to a relatively inhomogeneous distribution of aluminium phosphate and the other components in the catalyst particles. The object of the present invention is to provide an aluminium phosphate-containing catalyst composition in which the aluminium phosphate and the other catalyst components are more intimately and homogeneously mixed.

It has now been found that this objective can be met by starting with an aluminium source and converting one part of this aluminium source to aluminium phosphate and the other part to another, Al-containing, catalyst component.

The invention therefore relates to a process for the preparation of an aluminium phosphate-containing composition wherein an aluminium source is converted partly to aluminium phosphate using a phosphorus-containing composition and partly to (i) an anionic clay and/or Al-M^{II} mixed metal (hydr)oxide using a divalent metal (M^{II}) source, (ii) an aluminosilicate using a silicon source, and/or (iii) a M^{II}-aluminosilicate using both a divalent metal source and a silicon source.

In the first main embodiment, part of the aluminium source is first reacted with a phosphorus-containing compound to form aluminium phosphate, after which the unconverted part of the aluminium source is reacted with a divalent metal source or a silicon source to obtain a composition comprising (a) aluminium phosphate and (b) an anionic clay, a Al-M^{II} mixed metal (hydr)oxide, aluminosilicate, and/or a M^{II}-aluminosilicate. Hence, this first main embodiment involves the following steps:

a. reacting a phosphorus-containing compound with an aluminium source to obtain a composition comprising aluminium phosphate and unreacted aluminium source, and

b. reacting the resulting composition with a divalent metal source and/or a silicon source to obtain a composition comprising (a) aluminium phosphate and (b) an anionic clay, an Al-M^{II} mixed metal (hydr)oxide, an aluminosilicate, and/or a M^{II}-aluminosilicate.

In the second main embodiment, part of the aluminium source is first reacted with a divalent metal source or a silicon source to form an anionic clay, an Al-M^{II} mixed metal oxide, an aluminosilicate, and/or a cationic clay, after which the unconverted part of the aluminium source is reacted with a phosphorus-containing compound to obtain a composition comprising (a) aluminium phosphate and (b) an anionic clay, a Al-M^{II} mixed metal (hydr)oxide, an aluminosilicate, and/or a M^{II}-aluminosilicate. Hence, this second main embodiment involves the following steps:

a. reacting an aluminium source with a divalent metal source and/or a silicon source to obtain a composition comprising (a) unreacted aluminium source and (b) an anionic clay, a Al-M^{II} mixed metal (hydr)oxide, aluminosilicate, and/or a M^{II} aluminosilicate, and

b. reacting the resulting composition with a phosphorus-containing compound to obtain a composition comprising (a) aluminium phosphate and (b) an anionic clay, a Al-M^{II} mixed metal (hydr)oxide, an aluminosilicate, and/or a M^{II}-aluminosilicate.

The process according to the invention, including both main embodiments, results in a substantially homogeneous mixture of aluminium phosphate with an aluminosilicate, an anionic clay, an Al-M^{II} mixed metal (hydr)oxide, and/or a M^{II}-aluminosilicate. Without the wish to be bound by theory, it is imagined that this is due to the conversion of single aluminium source starting particles to these different phases. This results in closer proximity and interaction of these phases and, hence, improved catalytic performance, as compared to published compositions.

The term “unreacted aluminium source” refers to an aluminium source that is not reacted to form aluminium phosphate (cf. the first main embodiment) or anionic clay, Al-M^{II} mixed metal (hydr)oxide, aluminosilicate, or a M^{II}-aluminosilicate (cf. the second main embodiment). However, the term “unreacted aluminium source” includes aluminium phases that differ from the aluminium source started out with. For instance, if flash-calcined aluminium trihydrate is used as the aluminium source at the start of the process and if this material is converted to boehmite during step a), this boehmite is covered by the term “unreacted aluminium source.”

### Phosphorus-Containing Compound

Suitable phosphorus-containing compounds include phosphoric acid and its salts, such as ammonium dihydrogen phosphate and diammonium hydrogen phosphate, ammonium hypophosphate, ammonium orthophosphate, ammonium dihydrogen orthophosphate, ammonium hydrogen orthophosphate, triammonium phosphate, sodium pyrophosphate, phosphines, and phosphites. Suitable phosphorus-containing compounds also include derivatives of groups represented by PX₃, RPX₂, R₂PX, R₁P, R₃P═O, RPO₂, RPO(OX)₂, PO(OX)₃, R2P(O)OX, RP(OX)₂, ROP(OX)₂, and (RO)₂POP(OR)₂, wherein R is an alkyl or phenyl radical and X is hydrogen, R or halide. These compounds include primary, RPH₂, secondary, R₂PH, and tertiary, R₃P, phosphines such as butyl phosphine; tertiary phosphine oxides, R₃PO, such as tributyl phosphine; primary, RP(O)(OX)₂, and secondary, R₂P(O)OX, phosphonic acids such as benzene phosphonic acid; esters of the phosphonic acids such as diethyl phosphonate, (RO)₂P(O)H, dialkyl phosphinates, (RO)P(O)R₂; phosphinous acids, R₂POX, such as diethylphosphinous acid, primary, (RO)P(OX)₂, secondary, (RO)₂POX, and tertiary, (RO)₃P, phosphites; and esters thereof such as monopropyl ester, alkyldialkyl phosphinites, (RO)P₂, and dialkyl phosphonite, (RO)₂PR esters. Examples of phosphite esters include trimethyl phosphite, triethyl phosphite, diisopropyl phosphite, butyl phosphite, and pyrophosphites such as tetrapyrophosphite. The alkyl groups in the mentioned compounds typically contain 1 to 4 carbon atoms. Other suitable phosphorus-containing compounds include phosphorus halides such as phosphorus trichloride, bromide, and iodide, alkyl phosphorodichloridites, (RO)PCl₂, dialkyl phosphorochloridites, (RO)₂PCl, alkyl phosphonochloridates, (RO)(R)P(O)Cl, and dialkyl phosphinoebloridates, R₂P(O)Cl.

The advantage of using organic phosphate-containing compounds is that the organic group may increase the porosity of the final product after a subsequent calcination.

### Aluminium Sources

The term “aluminium source” as used herein is defined as any form of alumina or aluminum trihydrate and calcined forms thereof, and any water soluble aluminum salt or aluminate. Suitable examples include aluminium oxides and hydroxides, such as transition alumina, aluminium trihydrate—such as Bauxite Ore Concentrate (BOC), bayerite, nordstrandite, and gibbsite—and its thermally treated forms (including flash-calcined aluminium trihydrate), alumina sol, alumina gel, amorphous alumina, and (pseudo)boehmite, aluminium chlorohydrol, aluminium nitrohydrol, alumina salts such as aluminium nitrate, aluminium chloride, aluminium sulphate, aluminium chlorohydrate, sodium aluminate, and mixtures thereof. The aluminium oxides and hydroxides are relatively inexpensive and do not tend to leave anions in the catalyst composition that have to be washed out or that may be emitted as environmentally undesirable gases upon beating.

### Divalent Metal Sources

Suitable divalent metal sources are compounds containing Mg²⁺, Ca²⁺, Ba²⁺, Zn²⁺, Mn²⁺, Co²⁺, Mo²⁺, Ni²⁺, Fe²⁺, Sr²⁺, Cu²⁺, or mixtures thereof. Suitable compounds of these metals are their oxides, hydroxides, carbonate, hydroxycarbonates, formates, acetates, nitrates, chlorides, etc. The oxides, hydroxides, carbonate, and hydroxycarbonates are relatively inexpensive and do not tend to leave undesired metal anions in the product.

### Silicon Source

Examples of suitable silicon sources include stabilised silica sols, silica gels, (stabilised) polysilicic acid, fumed silicas, precipitated silicas, tetra-ethylorthosilicate, water glass, and mixtures thereof.

### THE PROCESS ACCORDING TO THE FIRST MAIN EMBODIMENT

In the process according to the first main embodiment, the first step involves the reaction of a phosphorus compound with an aluminium source. In one embodiment, this reaction is conducted in aqueous solution or suspension at a temperature of about 25° C. to about 300° C. for about 0.5 hour to 3 hours. In other embodiments, the reaction is conducted at a temperature of about 50° C. to about 200° C. or about 70° C. to about 150° C. for about 0.5 hour to about 3 hours or about 1 hour to about 2 hours. The Al/P mole ratio in the reaction mixture in one embodiment is between about 1.5 and about 15, depending on the commercial application of the final product and, hence, on the desired aluminium phosphate content of the final composition.

The mixture of aluminium phosphate and unreacted aluminium source obtained in step a) is subsequently reacted with a divalent metal source and/or a silicon source (step b). This reaction is generally conducted by aging an aqueous suspension of the aluminium phosphate and the divalent metal source and/or the silicon source. If a divalent metal source is used, aging results in a composition comprising aluminium phosphate and anionic clay or Al-M^{II} mixed metal (hydr)oxide; if a silicon source is used, a composition comprising aluminium phosphate and an aluminosilicate will be formed, whereas the use of both a divalent metal source and a silicon source results in the formation of a composition comprising aluminium phosphate and a M^{II}-aluminosilicate.

The desired aging temperature depends on the desired composition, but generally is in the range of about 25° C. to about 375° C., about 50° C. to about 250° C., or about 80° C. to about 200° C. The pressure is at or above atmospheric, and in one embodiment is autogenous. The aging time ranges from about 20 minutes to about 12 hours, or from about 1 hour to about 6 hours.

For the preparation of compositions comprising aluminium phosphate and anionic clay, the pH of the mixture typically is in the range of from about 6 to about 13, more or from about 8 to about 1, while the mole ratio of divalent metal to unreacted aluminium—calculated as metals—is at least about 2, or about 3 to about 4.

For the preparation of compositions comprising aluminium phosphate and M^{II}-aluminosilicate, the pH of the mixture typically is in the range of from about 6 to about 13, or from about 8 to about 11. Typical mole ratios of divalent metal : silicon: unreacted aluminium—calculated as metals—in the mixture are 1:1:1 and 1:1:0.5.

For the preparation of compositions comprising aluminium phosphate and aluminosilicate, the weight ratio of silicon source to unreacted aluminium source strongly depends on the desired silica/alumina ratio of the desired aluminosilicate, which can vary within a wide range, Seeds or templates can be added to enhance the formation of the desired aluminosilicate.

### The Process According to the Second Main Embodiment

In the process according to the second main embodiment, the first step involves the reaction of an aluminium source with a divalent metal source and/or a silicon source. This reaction is generally conducted by aging an aqueous suspension of the aluminium source and the divalent metal source and/or the silicon source.

If a divalent metal source is used, aging results in a suspension comprising unreacted aluminium source and anionic clay; if a silicon source is used, a suspension comprising unreacted aluminium source and an aluminosilicate will be formed, whereas the use of both a divalent metal source and a silicon source results in a suspension comprising unreacted aluminium source and a M^{II}-aluminosilicate.

The desired aging temperature depends on the desired composition, but generally is in the range of about 25° C. to about 375° C., or about 50° C. to about 250° C., or about 80° C. to about 200° C. The pressure is at or above atmospheric, and in some embodiments autogenously. The aging time generally ranges from about 20 minutes to about 12 hours, and in one embodiment from about 1 hour to about 6 hours.

For the formation of a composition comprising unreacted aluminium source and anionic clay, the pH of the mixture is in the range of from about 6 to about 13, or from about 8 to about 11, while the mole ratio of aluminium to divalent metal—calculated as metals—is at least about 0.25, and can be from about 2 to about 4.

For the preparation of a composition comprising unreacted aluminium source and M^{II}-aluminosilicate, the pH of the mixture is in the range of from about 8 to about 12.

For the preparation of compositions comprising aluminium phosphate and aluminosilicate, the mole ratio of aluminium to silicon strongly depends on the desired silica/alumina ratio of the desired aluminosilicate, which can vary within a wide range. Seeds or templates can be added to enhance the formation of the desired aluminosilicate.

The obtained mixture comprising unreacted aluminium source and anionic clay, Al-M^{II} mixed metal (hydr)oxide, aluminosilicate, and/or a M^{II}-aluminosilicate is subsequently reacted with a phosphorus source (step b).

In some embodiments of this invention, this reaction is conducted in aqueous suspension at a temperature of about 25° C. to about 300° C. or of about 50° C. to 200° C. In one embodiment of this invention, the reaction is conducted in aqueous suspension at a temperature of about 70° C. to about 150° C., for about 0.5 hours to about 3 hours, or for about 1 hour to about 2 hours.

The mole ratio of unreacted aluminium to phosphorus in the reaction mixture typically is between about 1.5 and about 15, depending on the commercial application of the final product and, hence, on the desired aluminium phosphate content of the final composition.

### The Resulting Composition

The resulting composition comprises (a) aluminium phosphate and (b) anionic clay, Al-M^{II} mixed metal (hydr)oxide, aluminosilicate, and/or M^{II}-aluminosilicate.

Depending of the envisaged application of the composition, its amount of aluminium phosphate can be small (e.g. about 5 wt % to about 25 wt %, or about 10 wt % to about 20 wt %), high (about 50 wt % to about 90 wt %, or about 60 wt % to about 80 wt %), or medium (e.g. about 30 wt % to about 60 wt %, or about 50 wt %).

Anionic clays have a crystal structure consisting of positively charged layers built up of specific combinations of divalent and trivalent metal hydroxides between which there are anions and water molecules. Hydrotalcite is an example of a naturally occurring anionic clay in which the trivalent metal is aluminium, the divalent metal is magnesium, and the predominant anion is carbonate; meixnerite is an anionic clay wherein the trivalent metal is aluminium, the divalent metal is magnesium, and the predominant anion is hydroxyl. A variety of terms are used to describe the material that this specification refers to as an anionic clay. Hydrotalcite-like and layered double hydroxide are terms interchangeably used by those skilled in the art. In this specification we refer to these materials as anionic clays, comprising within that term hydrotalcite-like and layered double hydroxide materials.

Anionic clays that may be formed during the process according to the invention include Mg-Al anionic clay, Ca-Al anionic clay, Ba-Al anionic clay, Zn-Al anionic clay, Mn-Al anionic clay, Co-Al anionic clay, Mo-Al anionic clay, Ni-Al anionic clay, Fe-Al anionic clay, Sr-Al anionic clay, and Cu-Al anionic clay.

Al-M^{II} mixed metal (hydr)oxides include amorphous mixed aluminium and divalent metal oxides and/or hydroxides and cogels of aluminium and divalent metal oxides and/or hydroxides. The divalent metal can be selected from the list presented above.

The term aluminosilicate includes molecular sieves such as zeolite beta, MCM-41, MCM-22, MCM-36, mordenite, faujasite zeolites such as X-zeolites and Y-zeolites, pentasil-type zeolites like ZSM-5, and non-zeolitic solid acids such as silica-alumina.

M^{II}-aluminosilicates include (i) amorphous aluminosilicate cogels doped with a divalent metal typically selected from the list presented above and (ii) doped cationic clays that comprise silicon as the tetravalent metal, aluminium as the trivalent metal, and a divalent metal typically selected from the list presented above. Examples of such clays are smectites (including montmorillonite, hectorite, saponite, laponite™, and sauconite), bentonite, illites, micas, glauconite, vermiculites, attapulgite, and sepiolite.

### Additional Process Embodiments

The process according to the invention may be conducted batch-wise or in a continuous mode, optionally in a continuous multi-step operation. Such a continuous multi-step operation can be conducted in an apparatus comprising two or more conversion vessels, such as the apparatus described in the patent application published under No. US 2003-0003035 A1.

For example, a slurry containing the aluminium source and the phosphorus-containing compound (cf. the first main embodiment) or the divalent metal source and/or a silicon source (cf. the second main embodiment) is prepared in a feed preparation vessel. The slurry is continuously pumped through two or more conversion vessels. In the first conversion vessel, reaction step a) is performed. In the second conversion vessel silicon source and/or divalent metal source (cf. the first main embodiment) or phosphorus-containing compound (cf. the second main embodiment) is/are added to the slurry and step b) is performed.

If so desired, additives, acids, or bases may be added to the mixture in any of the conversion vessels. Each of the vessels can be adjusted to its own desirable temperature.

The reaction mixtures involved in the process according to the invention and/or the components added to these mixtures can be mechanically treated, e.g. milled or kneaded, either separately or in admixture and either before or during reaction. This mechanical treatment can be combined with a heat treatment. In this specification the term “milling” is defined as any method that results in reduction of the particle size. Such a particle size reduction can at the same time result in the formation of reactive surfaces and/or heating of the particles. Equipment that can be used for milling includes ball mills, high-shear mixers, colloid mills, micronisers, and electrical transducers that can introduce ultrasound waves into a slurry. Low-shear mixing, i.e. stirring performed essentially to keep the ingredients in suspension, is not regarded as “milling”. It will be clear that metal sources can only be milled if they are not dissolved.

If so desired, additives may be added to the mixture during any of the process steps. Alternatively, one of more of the metal sources used during the process might already contain (e.g. be doped with) one or more additives. Suitable additives include oxides, hydroxides, borates, zirconates, aluminates, sulphides, carbonates, nitrates, phosphates, silicates, titanates, and halide salts of rare earth metals (for instance Ce, La), Si, P, B, Group VI metals, Group VIII metals, alkaline earth metals (for instance Mg, Ca, and Ba), noble metals (e.g. Pd, Pt, Rh), or transition metals (for example W, V, Mn, Fe, Ti, Zr, Cu, Co, Cr, Ni, Zn, MO, Sn).

Also organic additives may be added, such as pore regulating agents (e.g. sugars, surfactants, polymers), organic acids or bases, and EDTA.

The use of a rare earth metal (RE) as an additive is useful in one embodiment of this invention. More in particular, this rare earth metal is used to form a RE-doped aluminium phosphate.

The resulting catalyst composition may be shaped, either during or after the process of the invention. For instance, it is possible to shape the mixture prepared in step a) before performing step b).

Before shaping, additional catalyst components can be added to the mixture, e.g. binders, clays (e.g. kaolin), zeolites (e.g. ZSM-5, zeolite beta, mordenite, REY, USY, RE-USY, delaluminated Y), etc.

Suitable shaping methods include spray-drying, pelletising, extrusion (optionally combined with kneading), beading, or any other conventional shaping method used in the catalyst and absorbent fields or combinations thereof. The amount of liquid present in the slurry used for shaping should be adapted to the specific shaping step to be conducted. It might be advisable to partially remove the liquid used in the slurry and/or add an additional or another liquid, and/or change the pH of the precursor mixture to make the slurry gellable and thus suitable for shaping. Various additives commonly used in the various shaping methods such as extrusion additives may be added to the precursor mixture used for shaping.

The resulting composition, either before or after shaping, can be subjected to ion-exchange. Anions suitable for exchanging anionic clay-containing compositions include carbonate, bicarbonate, nitrate, chloride, sulphate, bisulphate, vanadates, tungstates, borates, phosphates, silicates, aluminates, pillaring anions such as HVO₄⁻, V₂O₇⁴⁻, HV₂O₁₂⁴⁻, V₃O₉³⁻, V₁₀O₂₈⁶⁻, Mo₇O₂₄⁶⁻, PW₁₂O₄₀³⁻, B(OH)₄⁻, B₄O₅(OH)₄²⁻, [B₃O₃(OH)₄⁻, [B₃O₃(OH)₅]²⁻, HBO₄²⁻, HGaO₃²⁻, CrO₄²⁻, and Keggin-ions, formate, acetate, oxalate, and mixtures thereof.

Cations suitable for exchanging smectite clay and/or aluminosilicate-containing compositions include NH₄^{+, Na}⁺, K⁺, Al³⁺, Ni²⁺, Cu²⁺, Fe²⁺, Co²⁺, Zn²⁺, other transition metals, alkaline earth and rare earth metals, and pillaring cations such as [Al₁₃]⁷⁺ Keggin ions.

The catalyst composition may optionally be calcined at temperatures between about 300° C. and about 1200° C., or between about 300° C. to about 800° C., or from about 300° C. to about 600° C. for about 15 minutes to about 24 hours, or from about 1 hour to about 12 hours, or from about 2 hours to about 6 hours.

### Use of the Resulting Composition

The resulting catalyst composition can suitably be used in a fluid catalytic cracking (FCC) catalyst or FCC catalyst additive. It is particularly suitable in FCC as additive for the reduction of SOₓ and NOₓ emissions from the FCC regenerator, the production of fuels with low sulphur and/or nitrogen content, the passivation of metals such as Ni and V, and to increase the olefin yield.

1. (canceled)

2. A process for the preparation of an aluminium phosphate-containing composition comprising the steps of:
a. reacting a phosphorus-containing compound with an aluminium source to obtain a composition comprising aluminium phosphate and unreacted aluminium source, and
b. reacting the resulting composition with a divalent metal (M^{II}) source and/or a silicon source to obtain a composition comprising (i) aluminium phosphate and (ii) an anionic clay, a Al-M^{II} mixed metal (hydr)oxide oxide or hydroxide, an aluminosilicate, and/or a M^{II}-aluminosilicate.

3. A process according to claim 2 wherein steps (a) and (b) are reversed.

4. The process according to claim 2 wherein the phosphorus-containing compound is selected from the group consisting of phosphoric acid, ammonium dihydrogen phosphate, diammonium hydrogen phosphate, ammonium hypophosphate, ammonium orthophosphate, ammonium dihydrogen orthophosphate, ammonium hydrogen orthophosphate, triammonium phosphate, sodium pyrophosphate, phosphines, phosphites, and mixtures thereof.

5. The process according to claim 2 wherein the divalent metal source is selected from the group consisting of Mg, Zn, Ni, Co, Fe, Mn, Ca, and Ba.

6. The process according to claim 5 wherein the divalent metal source is an oxide, hydroxide, carbonate, or hydroxycarbonate of the divalent metal.

7. The process according to claim 2 wherein a rare earth metal is present during at least one of the reaction steps.

8. A composition comprising (a) aluminium phosphate and (b) an anionic clay, a Al-M^{II} mixed metal oxide or hydroxide, an aluminosilicate, and/or a M^{II}-aluminosilicate, which composition is prepared by the process of claim 2.

9. The composition of claim 8, which additionally contains a rare earth metal.
